(19) United States
(12) Patent Application Publication
(10) Pub. No.: US 2021/0246007 A1
(43) Pub. Date: Aug. 12, 2021

(54) TREE AND POLE STABILIZATION TOOL

(71) Applicant: Adam A. Cavazos, Brookkshire, TX (US)

(72) Inventor: Adam A. Cavazos, Brookkshire, TX (US)

(21) Appl. No.: 17/170,223

(22) Filed: Feb. 8, 2021

Related U.S. Application Data
(60) Provisional application No. 62/971,590, filed on Feb. 7, 2020.

(51) Int. Cl. B66F 11/00; A01G 23/00

(52) U.S. Cl. CPC B66F 11/00; B66F 2700/09; A01G 23/003

(57) ABSTRACT

The disclosure pertains to a method and structure of securing a fallen tree or broken utility pole that has remained partially upright and in an insecure position, thereby creating a hazard to persons or property. The disclosure teaches a stand or similar structure that secures the partially fallen tree or pole during removal operations. The stand is load bearing and may be supported by at least one angled stabilizing leg structure. The structure may rest on ground support plates. The support plates may be attached to the ground by spike or anchor mechanisms. The stand can be extendable utilizing hydraulic or manual levered jacks or an extendable piston-cylinder combination. The structure can be placed under the fallen tree or pole and extended vertically upward into contact with the tree trunk or pole. The structure may use lifting components comprising cylinder/piston combinations, telescoping pistons, scissor lift components or similar.

### RELATED APPLICATION

This application claims priority to provisional application 62/971,590 entitled “Tree and Pole Stabilization Tool” filed Feb. 7, 2020 and to which is incorporated herein by reference in its entirety.

### FIELD OF USE

Trees are blown over or fall due to age. The fallen tree can strike building structures such as homes. The trees can also be hung up by the canopy and branches of nearby trees. This makes the removal of the tree hazardous and the removal process may cause injury to persons or further damage to structures.

Electrical power poles can also be damaged and lean precipitously after storms or other incidents such as vehicle collisions. The poles may be partially held upright by power cables. The top of the poles may contain multiple heavy transformers. These transformers will need to be removed as part of clearing of the broken pole. The power lines must also be disconnected as part of the steps to restore power. The damaged pole may shift and twist as cleanup work is performed.

### SUMMARY DESCRIPTION OF DISCLOSURE

This disclosure teaches structures or apparatus that can be used in the removal or disassembly downed trees, utility poles or other structures. The disclosure teaches an apparatus that can lift or stabilize the tree, etc. (Hereinafter the term tree will be used but it understood that the disclosure also applies to utility or light poles or other structures such as towers.) This stability will allow the tree to be lifted upward to allow removal or disassembly of structures upon which the tree has fallen such as garages, homes or other structures. It will facilitate the safe removal of items from these structures. The weight of the tree will no longer rest upon the garage, etc.

The apparatus of this disclosure can have several embodiments. One embodiment will be a portable jack stand that can be transported to the site. To facilitate transportation, the jack stand (which may be a cylinder/piston combination or similar device) can be carried to the site in multiple components that can be assembled on site. For example, the cylinder, when assembled, can utilize a plurality of support legs that will secure and stabilize the cylinder in a vertical orientation relative to the ground surface. To lessen the weight and size of the device when transporting to the site, the support legs can be removed. Also the cylinder and each leg will have a support base to distribute the weight of the device (and tree) across a ground surface. These bases may also be detachable when transported and positioned and re-attached on site.

In an embodiment, one or more support legs can be of adjustable length (extendible) to allow for an uneven ground surface. Also at least one of the support legs can be positioned in a varying angle to the vertically oriented cylinder.

Another embodiment is a wheeled trailer type of device that comprises scissor lifts or telescoping lift components. The wheeled device will be appreciated to allow the assembled lifting/stabilizing device to be transported to a remote site without disassembly and re-assembly on site.

In another embodiment, dual lifting components may be used. The dual lift components may be two jack stands placed side by side and on opposite sides of the axis of the trunk. The two lifting components may be joined by and support a single cradle that is positioned beneath the trunk. When the lifting components are raised (elevation of jack stand, scissor lift, telescoping lift, etc.) the cradle engages with the trunk. The cradle, in conjunction with the lifting components, supports the weight of the tree and may lift the tree.

Other embodiments that will become apparent to persons skilled in the art after reading this disclosure and accompanying drawings are included within the scope of this disclosure.

### SUMMARY DESCRIPTION OF DRAWINGS

The accompanying drawings, which are incorporated in and constitute a part of the specification, illustrate preferred embodiments of the disclosure. These drawings, together with the general description of the disclosure given above and the detailed description of the preferred embodiments given below, serve to explain the principles of the disclosure. It will be appreciated that the drawings are not to scale. Also details of the illustrated structures that will be readily understood by persons skilled in the art are not shown.

FIG. 1 illustrates a fallen tree and tree canopy (containing multiple and variously oriented tree limbs). Also illustrated in the vertical component of the disclosure resting upon a ground support plate and a vertically oriented cylinder containing a piston and extending piston shank pivotably attached to the top component. The top component is in contact with the angled tree trunk. The top component attaches one or more collars that encircle the circumference of the tree trunk and prevent rotation or twisting of the trunk.

FIG. 2A illustrates a top view of the ground support plates of five legs of one embodiment of the disclosure. The five legs of this embodiment support the vertical orientation of the center elevating or extendable jack or piston/cylinder combination (or similar). The support plates can form a star pattern. One plate at the apex of the pattern is positioned under the axis of the tree trunk (or pole).

FIG. 2B illustrates another embodiment showing the star pattern of the ground support plates, as well as the center vertical support plate

FIG. 3 illustrates a side view of the vertical component supported by a leg. Each component is supported by a ground base plate. The leg is extendable. This may facilitate correct positioning on uneven ground surfaces. In the embodiment illustrated the leg has a pivoting or hinged relationship with the ground support plate. Therefore the angle of attachment may vary. The extendable leg (which may, in one embodiment, comprise a threaded inter shaft within a cylinder structure) also has a hinged or pivoting relationship with the side of the vertical component (cylinder).

FIG. 4A is a top view of a ground support plate. The plate may be metal or other high strength material. Light weight high strength material may be preferred. The ground support plate is illustrated as containing perforations through which spikes or similar anchors can be positioned vertically into the ground to prevent lateral (horizontal) movement of the ground base support.

FIG. 4B is a side view of the ground base support plate with spikes positioned vertically into the ground surface. Other embodiments are within the scope of this disclosure.

FIG. 5 illustrates a rigid segmented collar that encircles the tree trunk. The collar is attached to the top component or plate. The collar can be tightened and the circumference of the collar reduced by adjustment or tightening subcomponents at or attached to the top component. Illustrated in this embodiment are teeth or similar structures capable of biting into and though the tree bark to secure the trunk against twisting or rotating.

FIG. 6 is a perspective view of an embodiment of the disclosure. Illustrated in the vertically oriented piston and cylinder combination. Atop the vertically extendable piston is a cradle attached with a ball joint allowing the cradle to have a variable planar position to the piston. The cylinder/piston combination is supported by a ground support plate. The vertically oriented cylinder/piston combination is also supported by 2 fixed angle and length support legs (rear legs) and three hinged and extendable support legs (2 front legs and one front center leg). Each support leg is attached to a flat weight distributing base for placement on the ground.

FIG. 7 illustrates an embodiment for securing and adjusting the angle of the support leg to the cylinder wall. A plate containing a plurality of holes extends from the support leg toward the cylinder wall. Also a similar plate with a plurality of holes extends from the cylinder wall toward the support leg. The two plates are posited adjacent to the other. A pair of holes can be aligned and a bolt placed through the holes to secure each support leg at a fixed angle to the vertically oriented cylinder.

FIG. 8A is a perspective view of another embodiment of the disclosure wherein the disclosure comprises two side by side scissor lift components mounted in a wheeled frame. The scissor lifts are shown in a flat (un-elevated) position. Also shown are wheels allowing for movement of the frame across the ground. Also illustrated is one of four extendible “out-riggers” or “booms” that, when deployed, provide enhanced stability to the frame and lift device.

FIG. 8B is a further perspective view showing the scissor lifts extended, thereby raising a cradle that can be secured to a tree trunk for lift and stability.

FIG. 8C is a further perspective view showing the scissor lifts extended and joined by a cradle component bridging between the two lift arms of the separate side by side cylinders (scissor lifts).

### DETAILED DESCRIPTION OF THE DISCLOSURE

This disclosure teaches a portable stand or structure that can secure the tree, pole or other structure into a fixed position while cleanup work is performed. It may also provide support for the collapsed tree or pole, etc., thereby limiting further damages to structures upon which the tree or pole has collapsed.

The portable stand can prevent from further movement as portions of the fallen tree are cut away for disposal. It will be appreciated that as tree limbs are cut away, the weight of the remaining tree can shift, causing the tree to twist and turn unexpectedly placing the worker or workers in or near the tree in jeopardy. The shift in the tree can also cause further property damage.

The stand can be transported to site. In one embodiment the stand can be disassembled and assembled on site. This can be particularly useful for removal from remote or vehicle inaccessible areas.

One component of the disclosure is a jack stand or moveable piston housed in a cylinder. This component can be placed on a stand or plate distributing weight over a portion of ground surface. The component is vertically oriented between the ground and a portion of the tree, e.g., the tree trunk or leaning utility power pole. It will be appreciated that the remainder of this disclosure may speak in terms of fallen tree remediation but that the structure or component taught of this disclosure may be equally useful for remediation of utility light and power poles, etc.

The component, which is expandable, can be elevated to be placed in contact with the trunk above the component. For example, the piston can be mechanically or hydraulically elevated out of the cylinder to engage the surface of the tree trunk. The expandable component may comprise a cylinder/piston combination. In another embodiment, the lift mechanism or component may be a scissors lifting component wherein the cylinder and piston can start from an approximately horizontal position and, upon expansion, cause a lift arm to vertically elevate. The cylinder piston combination will also pivot to an approximately vertical position. In yet another embodiment, there may be multiple nested piston-like components that are elevated in a vertical direction from a cylinder component. This is referred to as a telescoping lift device or mechanism.

The cylinder/piston combination or telescoping piston embodiment may be hydraulically operated. A power supply, e.g., battery, and a pump are not shown. The jack stand may also be mechanically operated by a lever/rachet combination or turning crank.

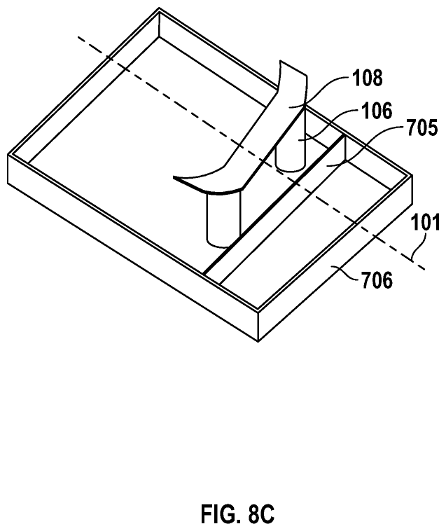

It will be appreciated that the disclosure includes a combination of lifting devices. For example two scissor lifts can be position as illustrated in FIGS. 8A, 8B and 8C as discussed below.

The tree trunk may be resting partially upon a structure such as a house or garage. In most events, the tree truck is positioned at an angle to the ground surface. For example the tree trunk can be resting at approximately 30° to 65° to the ground surface.

The component will have a top component that contacts or engages with the tree trunk. The top component may have a pivotable surface that can conform to the angle of tree. This component may sometime be referred to as the cradle. The cradle may pivot atop the piston on a hinged or ball and socket connection. This pivoting capacity can accommodate the angled tree trunk relative to the ground upon which the cylinder and piston are positioned. The cradle may have a further extendable portion that facilitates close and secure attachment to the bottom of the trunk surface. In one embodiment the top surface of the cradle may have protrusions or teeth that bite into the tree surface to enhance stability.

The top component may have one or more straps or collars that may be positioned around the trunk to encircle the trunk and secure it to the cradle or piston. In other embodiments, the top component may be adapted to hold teethed collars tightly against and at least partially around the trunk. The teethed structures may bite into and through the outer tree bark to prevent twisting or rotational movement of the tree trunk during the de-limbing of the tree canopy. This would equally apply to leaning power or utility poles as structures are removed from the upper portions of the poles, e.g., heavy transformers. It will be appreciated that the device used for downed power poles may not have teethed attachments that damage the structure for situations where the pole may be salvaged and reused.

Again, the vertical component of the stabilizing device subject of the disclosure is expandable in the vertical direction. The component may be a hydraulic powered jack that expands and presses up against tree trunk, thereby transferring part of the weight of the tree to the ground beneath the jack. In another embodiment, the vertical component may be an extendable piston within a cylinder. The path of movement of the piston is vertically upward and similarly can extend to the trunk and transfer weight to the ground. Manual levered or screw controlled jacking mechanisms may also be employed. The screw controlled jacking mechanism may be controlled by a turning wheel or handle.

As already mentioned, the top of the extending vertical component contains a top cradle that engages with the tree trunk surface (at an angle to the horizontal). The connection or attachment juncture between the top of vertical component, e.g., top of the piston shank, and the top component may allow the cradle to pivot to create an angle to the ground surface. This pivoting allows maximum contact between the cradle and the surface of the tree truck (or pole surface).

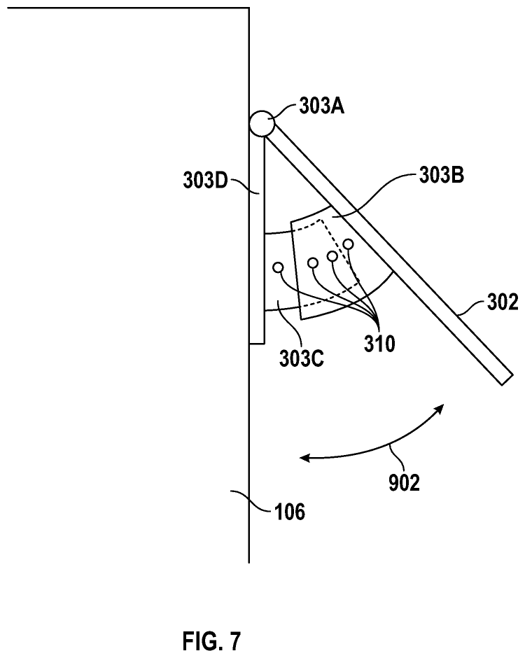

Various designs or configurations of the top component to the trunk surface are subject of this disclosure. In one embodiment, the top component may serve as the attachment device for one or more flexible straps that may be threaded through or otherwise attached to the cradle wherein the straps are wrapped and tightened about the circumference of the trunk surface. In another embodiment, the straps can be chains that are tighten around the trunk surface. In yet another embodiment, the cradle may be attached to tighten-able rigid segment wherein each segment may contain protrusions or teeth that bite into and through the trunk bark to engage the underlying wood trunk structure, thereby ensuring the twisting or rotation of the trunk is not possible. See FIG. 5 discussed below. In an embodiment, this structure positioned and tightened around the trunk structure may grip the trunk like pressurized vice grips. The top component may comprise multiple rigid portions each hinged together to allow the component links to tighten around various sized trunk diameters.

An important subcomponent may be multiple plates that are horizontally positioned on the ground surface. One such plate is positioned beneath the vertical component (cylinder) discussed above. This plate distributes the weight over an area of ground surface.

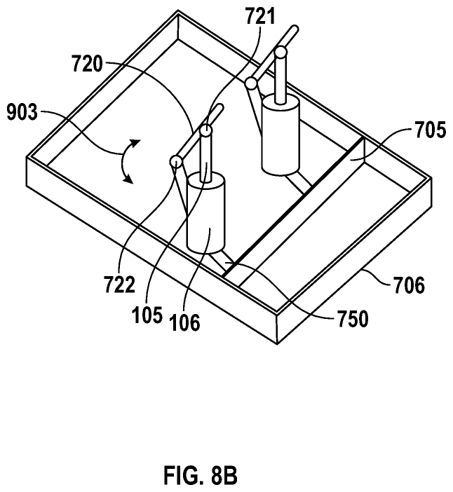

The vertical orientation of the vertical component, e.g., jack stand or piston/cylinder configuration, can be maintained by one or more extendable support legs that extend from the vertical component, e.g., cylinder/piston combination, at an angle. The cross section of the legs can be round (tubular) or rectangular, e.g., square. Each leg is similarly supported or positioned on a horizontally oriented plate positioned on the ground surface. In one embodiment, each leg can be attached with a chain or cable secured proximate to the bottom portion of the leg and vertical component. The cable or chain may prevent the one or more legs becoming splayed away from the vertical component and no long providing support. The chain or cable may be adjustable. In another embodiment, a hinged support leg can be secured with variable angled attachment plates having complementary bolt or anchor holes, i.e., a plate extends from the support leg toward the cylinder wall and is positioned adjacent to a plate extending from the cylinder wall. See FIG. 7 discussed below. Both the support leg plate and cylinder wall plate have multiple holes that can be complementarily aligned and anchor bolts inserted into the aligned holes to secure a variably positioned support leg angle to the cylinder wall.

In one embodiment of the disclosure, there can be five supporting legs. In another embodiment, there may be 2 or more legs. The ground “foot print” of the embodiment comprising 5 supporting legs can resemble a five pointed star. In an embodiment, two supporting legs can be positioned on each side of the trunk, each approximately parallel to the longitudinal axis of the tree trunk. The fifth supporting leg extends from the vertical component to the ground (supported by a base plate forming an apex of the star pattern) and in line with the longitudinal axis of the tree trunk.

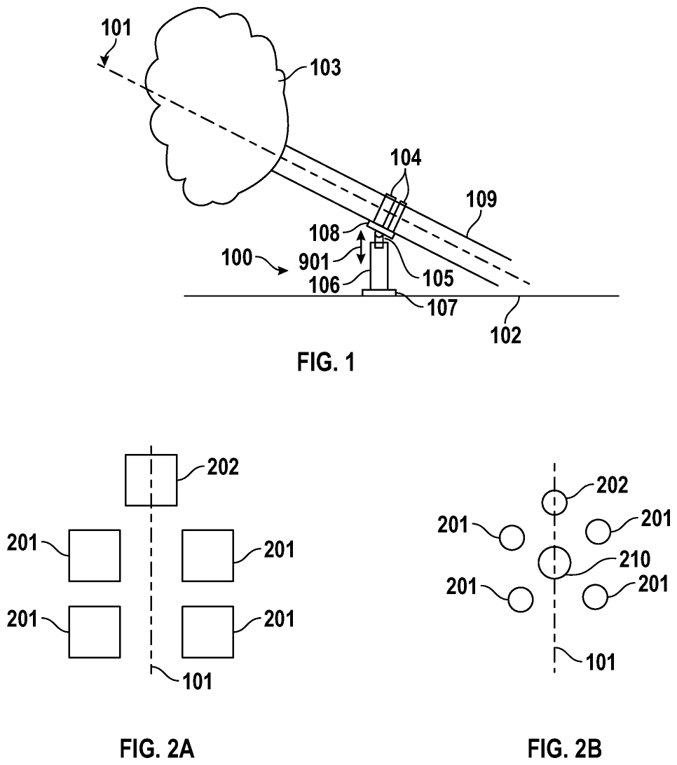

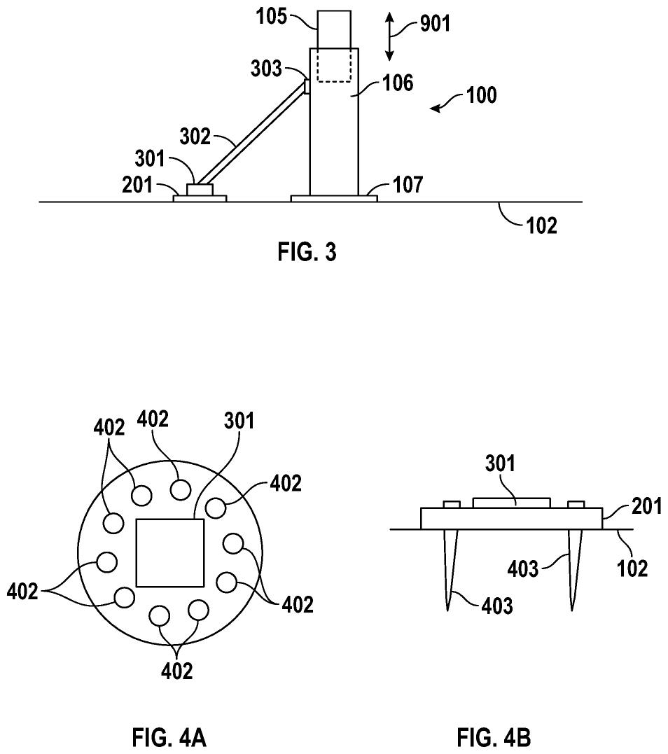

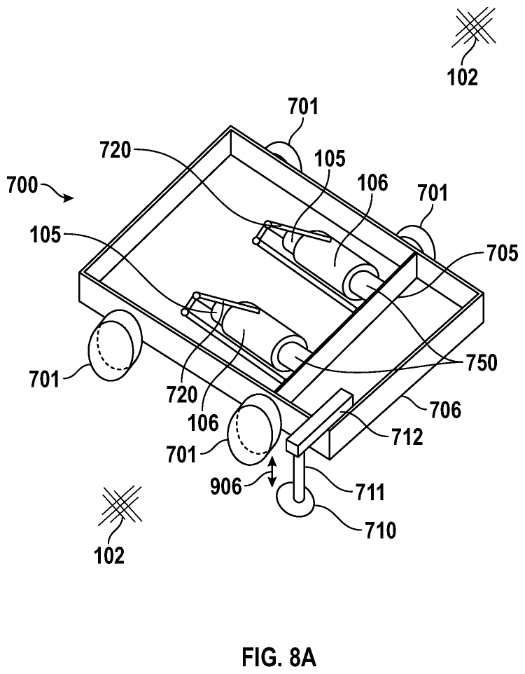

FIG. 1 shows one embodiment 100 of the disclosure. Illustrated is a side view of the vertical component, e.g., cylinder 106 and piston 105 positioned on a support plate 107 extending between the ground 102 and angled surface of the tree trunk 109. The cradle 108 (top component) connected to the top of the piston 105 with a pivoting head accommodates the angle of the fallen tree. The angle orientation of the tree trunk to the vertical position is shown by the axis 101. One embodiment of collars 104 is also shown that are tightened across the circumference of the tree trunk. The collars may be flexible straps attachable to the cradle 108 or top of piston 105. In another embodiment the collars may be rigid segment. See FIG. 5. Also illustrated in FIG. 1 is the tree canopy 103. The disclosure holds the tree in a stable position as the canopy is de-limbed. It will be appreciated that removal of portions of the canopy may shift the weight distribution and cause torsional strain upon the cradle and vertical positioned components. This strain can be accommodated by the collar mechanism 104 and the stabilizing legs 302 illustrated in FIGS. 2 and 6.

FIGS. 2A and 2B illustrates a top view of the support plates 201 and 202 positioned on the ground surface. Each support plate supports a stabilizing leg (not shown) connected to the vertical components of the disclosure. In the illustrated embodiment, the pattern of the support plates forms the above mentioned star pattern. The axis of the fallen tree trunk is represented by the dashed line. FIG. 2B more clearly illustrates the star pattern with a sixth horizontal plate 210 positioned at the center of the formation as the support for the vertical component, e.g., cylinder (not shown).

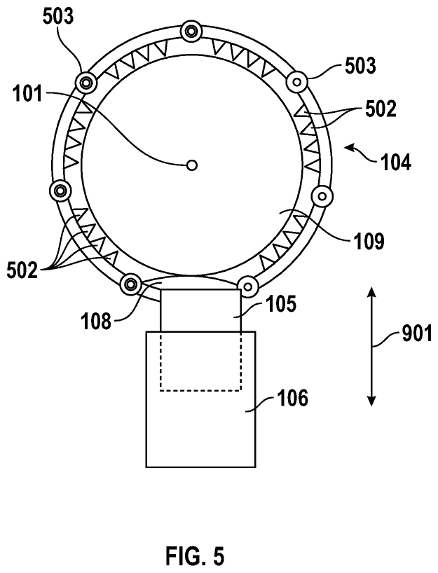

FIG. 3 illustrates the vertical oriented component, i.e., cylinder 106 and piston 105 combination, in relation to one stabilizing leg 302. Note that the leg is supported by a support plate 201. The junction or connection 301 with the stabilizing leg 302 and the support plate 201 may be fixed or flexible, e.g., a hinged connector. The connection 301 between the support leg 302 and the cylinder 106 may also be fixed or flexible. In one embodiment the “rear” two legs (most distal from the canopy 103) are fixed and the other three legs have a flexible connection to the respective support plates and cylinder wall. At least one support or stabilizing leg 302 is longitudinally extendable as shown by vector arrow 904 in FIG. 6.

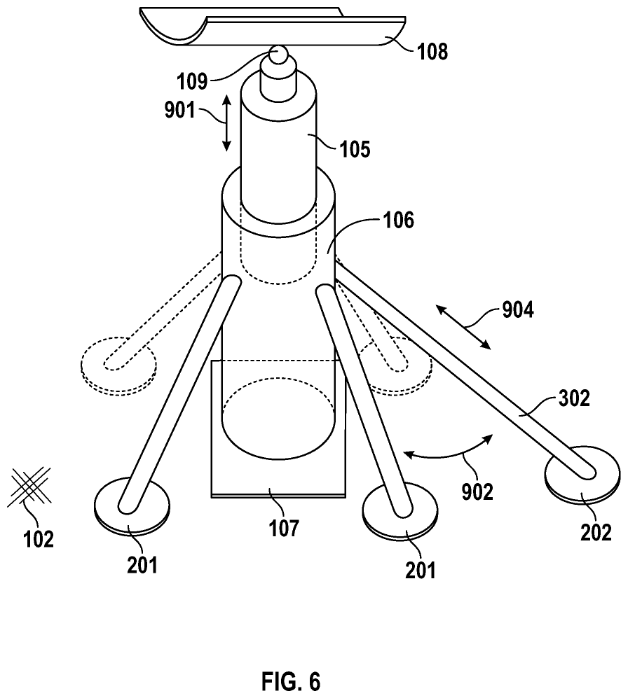

In a further embodiment illustrated in FIGS. 4A and 4B, each horizontal plate 201 (ground support plate for each stabilizing leg) may contain perforations 402 through which spikes or pins 403 may be inserted through the plate surface 201 and vertically into the ground 102. This can provide enhanced horizontal stability. In another embodiment, screw anchors may be inserted vertically into the ground. FIG. 4A illustrates a top view of a horizontal ground support plate 201 containing perforations 402 through which the vertical oriented spikes or anchors 403 may be inserted into the ground 102. It will be appreciated that such spikes or anchors will hinder lateral (horizontal) movement of the plates relative to the ground surface and thereby better secure the angled stabilizing legs 302 shown in FIG. 3 and maintaining the vertical orientation of the jack or piston/cylinder component.

The legs intersect and attach with the vertical wall or structural elements of the vertical component. The attachment may comprise a hinged or pivoting subcomponent. The attachment of the support leg can also be hinged or pivoting. The attachment can comprise two compatible dimensioned substructures that can be joined by a removable pin or similar configuration that can be dis-assembled and which facilitates transport of the device in component parts and assembly and interconnection at the site of the fallen tree. In one embodiment, the stabilizing leg attachment is with the wall of the vertically oriented cylinder. In another embodiment, the attachment can be located on the piston wall, cradle or other component. It will be appreciated that the cylinder does not elevate upon activation. However the piston, collar or other component will vertically extend when the jack or mechanism is activated.

In another embodiment (not shown), each leg may comprise two parts. The first component may removably extend substantially horizontally from the vertical component. The first component may also removably attach to a second lower leg segment that is vertically oriented and rests on the ground support. In an embodiment, the junction between the first leg component and second lower leg component may form a rigid angle such as a 90° angle.

Each support or stabilizing leg may be extendable. In one embodiment, length may be extended by a threaded rod element extending into the leg housing. In another embodiment, each support leg will comprise two or more separate telescoping segments. Each segment will contain complementary and evenly spaced holes. A pair of holes can be aligned on each support leg and an anchor bolt inserted through both leg segments to secure a specified length. This variable supporting leg length will be useful for situations in which the ground surface is uneven.

Returning to the top component, e.g., cradle, positioned atop the vertical component, e.g., piston, the top component may be fitted with collar attachment subcomponents. One or more collars may encircle the tree trunk. The collars may be tightened around the trunk. The collars, stabilized by the combined weight bearing vertical component and the multiple support legs, prevent the tree from twisting or turning (rotating) as limbs are removed from the tree. It facilitates the anchoring or fixing of the fallen tree into a single position.

Referring to FIG. 6 illustrating a perspective view of an embodiment of the disclosure such as a jack stand or cylinder/piston combination, the five support or stabilizing legs 302 are illustrated. It will be appreciated that the disclosure includes configurations comprising fewer or more than 5 legs. It will be appreciated that the disclosure does not require any support or stabilizing legs. See for example FIG. 1.

With reference to FIGS. 2A and 2B, the pattern of support plates 202, 201 illustrated in FIG. 6 creates a star pattern with support plate 202 forming the pinnacle of the star. Each support plate rest upon the ground surface 102. The vertically oriented cylinder 106 and piston 105 combination rests upon support plate 107 (designated 210 in FIG. 2B).

In the embodiment illustrated in FIG. 6, at least one stabilizing leg 302 is extendable as illustrated by vector arrow 904. In embodiments wherein the connection between the cylinder wall and angled stabilizing leg is flexible, the leg can move away from and form a variable angle with the cylinder as shown by vector arrow 902.

Also illustrated in FIG. 6 is the piston 105 extending within the cylinder 106 and vertically extendable/collapsible as shown by vector arrow 901. Positioned above the top end of the extended piston is a hinged or ball and socket connection component 109 connecting to the cradle 108. It will be appreciated that the pivoting cradle component can accommodate the angled tree trunk relative to the ground surface.

In another embodiment, a threaded rod fixed to the bottom of the cradle can be screwed into a complementary hole in the top of piston. It will be appreciated that there may be multiple sized cradles appropriate to the varying sized (diameter) trunks. This embodiment allows greater flexibility for dimensioning the cradle size to the particular situation. The threaded rod or bolt like structure extending from the bottom of the cradle can be hinge-ably attached or welded to the bottom of the cradle. Note that this embodiment can also be used for increasing or adjusting the height of the cradle relative to the top of the piston.

FIG. 7 illustrates an embodiment for securing and adjusting the angle of the support leg to the cylinder wall 106. A plate 303B containing a plurality of holes 310 extends from the support leg 302 toward the cylinder wall 106. Also a similar plate 303C with a plurality of holes 310 extends from the cylinder wall toward the support leg. The two plates are posited adjacent to the other. A pair of holes can be aligned and a bolt (not shown) or similar device placed through the aligned holes to secure each support leg at a fixed angle to the vertically oriented cylinder. Also illustrated is a pivoting or hinge component 303A and an attachment plate 303D attached to the cylinder wall. The hinged component also flexibly connects the stabilizing leg to the cylinder wall. This fix ably hinged movement is shown by vector arrow 902.

Referring to FIG. 8A, in another embodiment 700 of the disclosure, the device can utilize a variable positioned cylinder/piston combination such as a scissor lift jack or telescoping cylinder/piston combination. This embodiment 700 is referred to as a scissor lift device. A telescoping component has multiple pistons each having a differing diameter that nest within the next larger diameter piston component. It will be appreciated that the scissor and telescoping cylinder/piston combinations are frequently utilized for elevating a first end of a dump truck bed to discharge a load from the opposing second end of the truck bed. Such components and combinations will be understood by persons skilled in the art.

The scissor lift device 700 may be stabilized by the frame of the holding one or more scissor lift components. The scissor lift component (combination of a cylinder 106, piston 105 and lift arm 720) can be mounted on a wide horizontally oriented frame 706 and connected with a push plate 705 and integral to the frame. It will be appreciated that the wide frame will provide stability as the scissor lift component extends vertically upward and engages with the weight of the tree trunk or pole. This vertical movement is shown by vector arrow 903 in FIG. 8B.

In an embodiment, the frame 706 may be attached to extendable stabilizing legs or posts (boom) 710, 711, 712 that extend to the ground surface 102. See vector arrow 906. Only one such boom component is illustrated in FIG. 8A but it will be appreciated that a plurality of such booms can be positioned on opposing corners of the frame. In such an embodiment, the frame may incorporate horizontally extendible leg components that, when extended, increase the size of the scissor lift device “footprint” relative to the ground to provide additional stability. Such stabilizing component, termed “boom” or “ground support outriggers” are known to be utilized with load bearing cranes. This structure will be understood by persons skilled in the art. It will be further appreciated that the boom may be affixed to the bottom of the frame or integral to the frame. The elevation of the vertical oriented and extendable legs 711 may be hydraulically powered. The frame, understood may include four booms positioned at each frame corner, may be therefore elevated by hydraulically increasing the length of each extendable leg 711. These four legs may therefore assist in elevating the frame and the scissor lift component (including the cradle engaged with the tree trunk), thereby providing additional lift capability.

The frame holding the scissor lift components may be moved by one or more wheels 701. Four wheels are illustrated in FIG. 8A.

To provide enhanced stability, a plurality of scissor lift components can be utilized in the scissor lift device. For example, two scissor lifts can be positioned 750 on a push plate 705 integral to the device frame 706. Each lift component is used in tandem or cooperation with the other. The two scissor lifts are positioned with a horizontal axis of orientation parallel to the other. Stated differently, the two scissor lifts are positioned side by side as illustrated in FIGS. 8A, 8B and 8C. The extended component end of each scissor lift can be joined together by a cradle 108 that engages with the tree or pole. The orientation of the two scissor lift devices and cradle to the axis of the tree 101 is shown in FIG. 8C. Each scissor lift can be positioned relative to opposing sides of the tree, thereby providing additional stability against twisting or shifting of the tree trunk during lifting or during de-limbing of the tree crown.

It will be appreciated that the scissor lift device frame 706 can be mounted with one or more wheels 701. This will facilitate movement of the device across the ground to the location of the fallen tree, pole or other structure. It will also facilitate optimal positioning of the device under the tree, etc.

FIG. 8B illustrates the scissor lifts in a raised position. The two lift arms can support a cradle 108 that will engage the tree trunk. See FIG. 8C. The elevating motion of the scissor lift device is shown in comparison of FIGS. 8A and 8B. This motion is illustrated by vector arrow 903. The extension of the piston 105 out of the cylinder 106 causes the lift arm 720 to extend vertically on pivoting components 721, 722. The lift arm 720 is of a fixed length.

This specification is to be construed as illustrative only and is for the purpose of teaching those skilled in the art the manner of carrying out the disclosure. It is to be understood that the forms of the disclosure herein shown and described are to be taken as the presently preferred embodiments. As already stated, various changes may be made in the shape, size and arrangement of components or adjustments made in the steps of the method without departing from the scope of this disclosure. For example, equivalent elements may be substituted for those illustrated and described herein and certain features of the disclosure maybe utilized independently of the use of other features, all as would be apparent to one skilled in the art after having the benefit of this description of the disclosure.

While specific embodiments have been illustrated and described, numerous modifications are possible without departing from the spirit of the disclosure, and the scope of protection is only limited by the scope of the accompanying claims.

What I claim is:

1. A structure for securing and stabilizing downed trees and poles during removal or restoration activity comprising:
(a) an expandable vertical component position-able beneath a downed tree trunk or pole;
(b) a ground support plate placed on a ground surface under and supporting the expandable vertical component; and
(c) one or more legs attached to the expandable vertical component and extending to the ground surface.

2. The structure of claim 1 wherein the expandable vertical component comprises a cylinder and piston combination wherein the piston can be extended from the cylinder by mechanical, pneumatic or hydraulic components.

3. The structure of claim 2 further comprising a cradle attached to a top end of the piston extending out of the cylinder wherein the cradle engages with the tree or pole.

4. The cradle of claim 3 further comprising a concave surface to hold the tree or pole.

5. The cradle of claim 4 further comprising a teeth or protrusions on the cradle surface to engage the outer surface of the tree or pole.

6. The cradle of claim 3 further comprising a collar that can wrap around the tree or pole to secure the tree or pole to the cradle.

7. The collar of claim 4 further comprising protrusions or teeth that can engage the outer surface of the tree or pole.

8. The structure of claim 1 wherein an upper portion of the leg is attached to a side of the vertical component and bottom portion of the leg extends away from the vertical component at an angle and the bottom portion of the leg engages with the ground surface.

9. The leg of claim 8 wherein the upper portion of the leg is pivotably or hinge-ably attached to the side of the vertical component.

10. The leg of claim 8 wherein a length of the leg is extendable.

11. A mobile wheel frame lifting structure capable of securing and stabilizing downed trees or poles comprising:
a) a horizontally oriented frame;
b) at least one wheel attached to the frame to assist transport of the frame across a ground surface; and
c) a lifting component attached to the frame wherein the lifting component is in a substantially horizontal position when not deployed and extendable to a substantially vertical position to engage a downed tree or pole.

12. The structure of claim 11 further comprising a plurality of lifting components.

13. The structure of claim 12 wherein an extended upper end of each lifting component supports and shares a single cradle that engages with the downed tree or pole.

14. The structure of claim 11 wherein the lifting component comprises a scissor lift.

15. The structure of claim 11 wherein the lifting component comprises a telescoping lift component.

16. The structure of claim 11 further comprising a plurality of extendable booms attached to the frame to expand a foot print of the structure on the ground surface.

17. A method of securing or stabilizing a downed tree or pole comprising:
a) positioning a lifting mechanism on a ground surface beneath a tree or pole wherein the tree or pole has an axis of orientation;
b) mechanically, pneumatically or hydraulically extending a component of the lifting mechanism to engage the surface of the tree or pole with a cradle; and
c) securing the tree or pole to the cradle.

18. The method of claim 17 wherein the lifting component is a vertically oriented cylinder and piston combination further comprising:
a) stabilizing a vertically oriented cylinder and piston lift component with a ground support plate positioned on the ground surface beneath the cylinder; and
b) deploying at least one leg having an upper portion pivotably or hinge-ably attached to a side wall of the cylinder and extending at an angle away from the cylinder and a lower portion of the leg engaging the ground surface.

19. The method of claim 17 further comprising:
a) positioning a well mounted and horizontally oriented frame on a ground surface beneath the downed tree or pole;
b) extending a plurality of booms from the frame to expand the foot print of the frame on the ground surface wherein each boom has extendable legs that can engage the ground surface; and
c) activating and deploying a scissor lift or telescoping lift component of the lifting mechanism to elevate the cradle to engage the tree or pole.
